(19) United States
(12) Patent Application Publication
(10) Pub. No.: US 2015/0017707 A1
(43) Pub. Date: Jan. 15, 2015

(54) STORAGE-STABLE LIQUID DISHWASHING DETERGENT CONTAINING PROTEASE AND AMYLASE

(71) Applicant: BASF SE, Ludwigshafen (DE)

(72) Inventors: Nina Mussmann, Willich (DE); Thomas Eiting, Dusseldorf (DE); Thorsten Bastigkeit, Wuppertal (DE); Konstantin Benda, Dusseldorf (DE); Hans Hartmut Janke, Korschenbroich (DE)

(73) Assignee: BASF SE, Ludwigshafen (DE)

(21) Appl. No.: 14/375,183

(22) PCT Filed: Jan. 25, 2013
(86) PCT No.: PCT/EP2013/051392

§ 371 Date: Jul. 29, 2014

(30) Foreign Application Priority Data
Feb. 2, 2012 (DE) 102012201522.1

(51) Int. Cl. C11D 3/386

(52) U.S. Cl. CPC C11D 3/38618; C11D 3/38645; C11D 3/38636; C11D 3/38654; C11D 3/38627
USPC 435/264; 510/218; 510/221

(57) ABSTRACT

In a liquid dishwashing detergent comprising a protease and amylase, storage stability is to be improved. This is achieved through the use of a protease comprising an amino acid sequence having at least 70% identity over its total length with the amino acid sequence specified in SEQ ID NO. 1 and having, in the listing according to SEQ ID NO. 1, the L211D amino acid substitution in combination with at least two further amino acid substitutions selected from the group consisting of S3T, V4I, V193M and V199I.

The invention is in the field of the liquid dishwashing detergents. The invention relates particularly to liquid enzyme-containing dishwashing detergents comprising defined proteases in combination with an amylase, and also proposes methods in which such compositions are employed. The invention further relates to uses of defined proteases in liquid dishwashing detergents comprising an amylase.

For dishwashing detergents, proteases of the subtilisin type are used with preference. The proteases used in the dishwashing detergents known from the prior art originate either from microorganisms, for example from the Bacillus, Streptomyces, Humicola, Thermomyces or Pseudomonas genera, and/or are produced by biotechnology methods known per se through suitable microorganisms, for example through transgenic expression hosts of the Bacillus genus or through filamentous fungi.

Especially in modern dishwashing detergents, further enzymes are increasingly present, including amylases in particular. An amylase is an enzyme which catalyzes the hydrolysis of glycoside bonds, especially in polysaccharides such as starch. Among the amylases, α-amylases, which hydrolyze the α(1-4)-glycoside bonds of amylose, are often used in dishwashing detergents. In the EC classification of enzymes, the numerical classification system for enzymes, α-amylases have the EC number (“Enzyme Commission number”) 3.2.1.1 and consequently form part of the third of the six main enzyme classes, the hydrolases (E.C.3.-.-.-), among these of the glycolases (E.C. 3.2.-.-), and among these in turn of the glycosidases (E.C. 3.2.1.-), i.e. enzymes which hydrolyze O- and/or S-glycoside compounds. Starch degradation by α-amylases forms dextrins and, from these, maltose, glucose and branched oligosaccharides. Amylases are consequently active particularly against starch-containing residues in the wash and catalyze the hydrolysis thereof.

International patent applications WO 95/23221 and WO 92/21760 disclose variants of the alkaline protease from Bacillus lentus DSM 5483, which are suitable for use in washing or cleaning compositions, including dishwashing detergents, and washing and cleaning compositions comprising such proteases. In addition, international patent application WO 2011/032988 discloses washing and cleaning compositions which likewise comprise variants of the alkaline protease from Bacillus lentus DSM 5483. The protease variants disclosed in these documents may, as well as at further positions, be modified at positions 3, 4, 193 and 199 in the numbering of the alkaline protease from Bacillus lentus DSM 5483 and have, for example, the amino acids 3T, 41, 193M and 1991 at said positions. It is also disclosed that the washing compositions may comprise further enzymes, also including an amylase. The washing compositions may be solid or liquid. However, these documents do not directly and unambiguously disclose a liquid dishwashing detergent comprising an amylase in combination with a protease having the combination of these modifications as described above.

A disadvantage of protease- and amylase-containing liquid dishwashing detergents from the prior art is that they are not sufficiently storage-stable and they accordingly lose a considerable degree of enzymatic, especially amylolytic and/or proteolytic, activity after only a short time. Frequently, the presence of protease leads to loss of amylolytic activity, since the protease inactivates the amylase. The dishwashing detergent then no longer exhibits optimal cleaning performance.

It is an object of the present invention to overcome the disadvantage mentioned and to provide protease- and amylase-containing liquid dishwashing detergents having sufficient or improved storage stability, especially in terms of the enzymatic and preferably amylolytic and/or proteolytic activity thereof.

The invention therefore provides a liquid dishwashing detergent comprising

(a) a protease comprising an amino acid sequence having at least 70% identity over its total length with the amino acid sequence specified in SEQ ID NO. 1 and having, in the listing according to SEQ ID NO. 1, the L211D amino acid substitution in combination with at least two further amino acid substitutions selected from the group consisting of S3T, V4I, V193M and V199I, and
(b) an amylase.

It has been found that, surprisingly, a liquid dishwashing detergent comprising the combination of such a protease with an amylase is advantageously storage-stable. More particularly, it has improved cleaning performance, especially improved amylolytic and/or proteolytic cleaning performance, after storage compared to a dishwashing detergent which differs from the inventive composition merely by the protease present in the particular composition, the protease having been present in the same concentration on commencement of storage in the compositions to be compared, based on active enzyme. A protease provided in the context of the present invention therefore leads to reduced inactivation of the amylase and also shows reduced performance losses itself. However, the reduced inactivation of amylase and/or protease by the protease provided in the context of the present invention is not founded on inadequate protease performance and/or activity. In preferred configurations of inventive dishwashing detergents, the improved storage stability described is also present at relatively high temperatures, for example at 30° C., 35° C. and/or even at 40° C.

In this regard and with preference, an inventive composition still has good, especially an advantageous, cleaning performance on protease-sensitive stains. Such a composition therefore enables satisfactory or improved removal of at least one, preferably of more than one, protease-sensitive stains on hard surfaces, for example dishware, or metal surfaces, for example cutlery. In selected configurations of the invention, such cleaning performance with respect to at least one protease-sensitive stain occurs particularly also at relatively high temperatures, especially between 40° C. and 70° C., between 40° C. and 60° C. or between 4Y and 55° C.

With respect to the international patent applications WO 95/23221, WO 92/21760 and WO 2011/032988 mentioned by way of introduction, the present invention is thus a particularly advantageous selection which leads to the achievement of a high-performance and storage-stable liquid dishwashing detergent, especially with regard to proteolytic and/or amylolytic cleaning performance of the composition after storage and/or with regards to proteolytic and/or amylolytic activity of the composition after storage.

The cleaning performance describes the ability of a dishwashing detergent, especially of a machine dishwashing detergent, to partially or completely remove a stain present from the hard surface of the dishware. Examples of dishware stains are milk, minced meat, egg yolk, oat flakes and starch. In the context of the invention, both the dishwashing detergent comprising the protease and the amylase, or the cleaning liquor formed by this composition, and the protease or the amylase itself has independent cleaning performance. The cleaning performance of the enzymes thus contributes to the cleaning performance of the composition or of the cleaning liquor formed by the composition. The amylolytic cleaning performance refers to the cleaning performance on amylase-sensitive stains. The proteolytic cleaning performance refers to the cleaning performance on protease-sensitive stains. The cleaning performance is determined in the manner customary in the art, preferably as specified below.

“Cleaning liquor” is understood to mean that use solution which comprises the dishwashing detergent and acts on the hard surfaces and hence comes into contact with the stains present on the hard surfaces. Typically, the cleaning liquor forms when the cleaning operation commences and the dishwashing detergent is diluted with water, for example, in a machine dishwasher or in another suitable vessel.

Storage stability in the context of the invention is present especially when an inventive dishwashing detergent, after storage, has a relatively high cleaning performance compared to a control composition which differs from the inventive dishwashing detergent only by the protease present in the control composition. The two compositions to be compared therefore have the same amount or concentration of amylase and/or amylolytic starting activity on commencement of storage. In addition, in the two compositions, the protease is present in the same concentration on commencement of storage, based on active enzyme, and the two compositions are treated in the same manner, especially with regard to the storage conditions and the determination of enzyme activity. With increasing preference, the storage is effected for at least 24 hours, 48 hours, 72 hours, 5 days, 1 week, 2 weeks, 3 weeks or 4 weeks. Further preferably, the storage is effected at a temperature of at least 35° C., more preferablyat 40° C.

In this regard, the enzyme activity can be effected in a manner customary in the art—matched to the particular enzyme type. Methods for determining activity are familiar to those skilled in the art in the field of enzyme technology and are used routinely by such skilled persons. Methods for determining protease activity are disclosed, for example, in Tenside, volume 7 (1970), p. 125-132. Proteolytic activity can also be determined by the release of the para-nitroaniline (pNA) chromophore from the suc-L-Ala-L-Ala-L-Pro-L-Phe-p-nitroanilide substrate (suc-AAPF-pNA). The protease cleaves the substrate and releases pNA. The release of the pNA causes an increase in the absorbance at 410 nm, and the course of the absorbance over time is a measure of the enzymatic activity (cf. Del Mar et al., 1979). The measurement is effected at a temperature of 25° C., at pH 8.6 and a wavelength of 410 nm. The measurement time is 5 min with a measurement interval of 20 s to 60 s. The protease activity is preferably reported in PE (protease units).

The amylase activity is determined in a manner customary in the art. Preferably, the amylase activity is determined as specified below. Amylases convert starch to glucose. Under defined reaction conditions (Tris-maleate buffer pH 6.5, 50° C., 15 min), the sarrples to be analyzed are incubated with 0.67% starch (soluble, pretreated according to Zulkowsky (treated with glycerol at 190° C.)). Through addition of dinitrosalicylic acid and heating to 100° C., thelatter is reduced by glucose and other reducing sugars under alkaline conditions to give an orange-red dye, which is determined photometrically at 540 nm after the reaction has ended. The amount of sugar released, which corresponds to the color, is a measure of the enzyme activity (cf. Sumner et al., J. Biol. Chem., 1921, 47 & 1924, 62).

More preferably, the presence of enzyme stabilization in the context of the present invention is determined as specified above using a protease- and amylase-containing liquid dishwashing detergent which is stored at a temperature of 40° C. for four weeks, the proteolytic activity being determined via the release of the para-nitroaniline (pNA) chromophore from the suc-AAPF-pNA substrate and the amylolytic activity being determined as specified above.

The protease present in an inventive dishwashing detergent comprises an amino acid sequence having at least 70% identity over its entire length with the amino acid sequence specified in SEQ ID NO. 1 and having, in the listing according to SEQ ID NO. 1, the L211D amino acid substitution in combination with at least two further amino acid substitutions selected from the group consisting of S3T, V4I, V193M and V199I.

In a further embodiment of the invention, the protease comprises an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identity over its total length with the amino acid sequence specified in SEQ ID NO. 1 and having, in the listing according to SEQ ID NO. 1, the L211D amino acid substitution in combination with at least two further amino acid substitutions selected from the group consisting of S3T, V4I, V193M and V199I.

SEQ ID NO. 1 is the sequence of the ripe (mature) alkaline protease from Bacillus lentus DSM 5483, which is disclosed in international patent application WO 92/21760, and which is hereby explicitly incorporated by reference.

Particularly preferred inventive proteases are:

protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identity over its total length with the amino acid sequence specified in SEQ ID NO. 1 and having, in the listing according to SEQ ID NO. 1, the L211D amino acid substitution in combination with the S3T and V4I amino acid substitutions, especially a protease according to SEQ ID NO. 1 with the S3T, V4I and L211D amino acid substitutions.
protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identity over its total length with the amino acid sequence specified in SEQ ID NO. 1 and having, in the listing according to SEQ ID NO. 1, the L211D amino acid substitution in combination with the S3T and V193M amino acid substitutions, especially a protease according to SEQ ID NO. 1 with the S3T, V193M and L211D amino acid substitutions.
protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identity over its total length with the amino acid sequence specified in SEQ ID NO. 1 and having, in the listing according to SEQ ID NO. 1, the L211D amino acid substitution in combination with the S3T and V199I amino acid substitutions, especially a protease according to SEQ ID NO. 1 with the S3T, V199I and L211D amino acid substitutions.
protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identity over its total length with the amino acid sequence specified in SEQ ID NO. 1 and having, in the listing according to SEQ ID NO. 1, the L211D amino acid substitution in combination with the V4I and V193M amino acid substitutions, especially a protease according to SEQ ID NO. 1 with the V4I, V193M and L211D amino acid substitutions.
protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identity over its total length with the amino acid sequence specified in SEQ ID NO. 1 and having, in the listing according to SEQ ID NO. 1, the L211D amino acid substitution in combination with the V4I and V199I amino acid substitutions, especially a protease according to SEQ ID NO. 1 with the V4I, V199I and L211D amino acid substitutions.
protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identity over its total length with the amino acid sequence specified in SEQ ID NO. 1 and having, in the listing according to SEQ ID NO. 1, the L211D amino acid substitution in combination with the V193M and V199I amino acid substitutions, especially a protease according to SEQ ID NO. 1 with the amino acid substitutions V193M, V199I and L211D.

In a further embodiment of the invention, the protease comprises an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98% and 98.5% identity over its total length with the amino acid sequence specified in SEQ ID NO. 1 and having, in the listing according to SEQ ID NO. 1, the L211D amino acid substitution in combination with at least three further amino acid substitutions selected from the group consisting of S3T, V4I, V193M and V199I.

Inventive proteases particularly preferred in this regard are:

protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98% and 98.5% identity over its total length with the amino acid sequence specified in SEQ ID NO. 1 and having, in the listing according to SEQ ID NO. 1, the L211D amino acid substitution in combination with the S3T, V4I and V193M amino acid substitutions, especially a protease according to SEQ ID NO. 1 with the S3T, V4I, V193M and L211D amino acid substitutions.
protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98% and 98.5% identity over its total length with the amino acid sequence specified in SEQ ID NO. 1 and having, in the listing according to SEQ ID NO. 1, the L211D amino acid substitution in combination with the S3T, V4I and V199I amino acid substitutions, especially a protease according to SEQ ID NO. 1 with the S3T, V4I, V199I and L211D amino acid substitutions.
protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98% and 98.5% identity over its total length with the amino acid sequence specified in SEQ ID NO. 1 and having, in the listing according to SEQ ID NO. 1, the L211D amino acid substitution in combination with the V4I, V193M and V199I amino acid substitutions, especially a protease according to SEQ ID NO. 1 with the V4I, V193M, V199I and L211D amino acid substitutions.

Further particularly preferred embodiments of the inventive proteases are notable in that they have the L211D amino acid substitution in combination with the four further amino acid substitutions S3T, V4I, V193M and V199I. More particularly, very particular preference is given in this regard to the following proteases:

protease comprising an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98% and 98.1% identity over its total length with the amino acid sequence specified in SEQ ID NO. 1 and having, in the listing according to SEQ ID NO. 1, the L211D amino acid substitution in combination with the S3T, V4I, V193M and V199I amino acid substitutions, especially a protease according to SEQ ID NO. 1 with the S3T, V4I, V193M, V199I and L211D amino acid substitutions. A protease of this kind is specified in SEQ ID NO. 2 and is very particularly preferred.

Further particularly preferred proteases are proteases as described above which also have, at position 99 in the listing according to SEQ ID NO. 1, the amino acid arginine (R) and/or which also have, at position 188 in the listing according to SEQ ID NO. 1, the amino acid alanine (A).

The amino acid positions are defined in the context of present invention by an alignment of the amino acid sequence of the protease to be used with the amino acid sequence of the protease from Bacillus lentus, as specified in SEQ ID NO. 1. Since the protease from Bacillus lentus in the prior art is an important reference molecule for description of proteases and of amino acid modifications, it is advantageous to make reference to the listing of the protease from Bacillus lentus (SEQ ID NO. 1) in the assignment of the amino acid positions. Moreover, the listing is guided by the ripe (mature) protein. This assignment is especially also to be employed when the amino acid sequence of the protease to be used comprises a higher number of amino acid residues than the protease from Bacillus lentus according to SEQ ID NO. 1. Proceeding from the positions mentioned in the amino acid sequence of the protease from Bacillus lentus, the amino acid positions in a protease for use in accordance with the invention are those which are assigned to precisely these positions in an alignment.

Particularly advantageous positions in addition to position 211 are accordingly positions 3, 4, 193 and 199, to be assigned an alignment with SEQ ID NO. 1 and hence in the listing according to SEQ ID NO. 1. In the positions mentioned, the following amino acid residues are present in the wild-type molecule of the protease from Bacillus lentus: S3, V4, V193, V199, and L211. Depending on the number of sequence differences present from SEQ ID NO.1, there are therefore different maximum identity values that a protease for use in accordance with the invention can have from SEQ ID NO. 1, even if they should correspond with SEQ ID NO. 1 in all the other amino acids. This fact should be taken into account in each individual case for any possible combination of the sequence modifications proposed in accordance with the invention, and is also dependent on the length of the amino acid sequence of the protease. For example, the maximum identity in the case of three, four, five, six, seven, eight or nine sequence modifications is, respectively 98.88%, 98.51%, 98.14%, 97.77%, 97.40%, 97.03% and 96.65% in an amino acid sequence of 269 amino acids in length, or, respectively, 98.91%, 98.55%, 98.18%, 97.82%, 97.45%, 97.09% and 96.73% in an amino acid sequence of 275 amino acids in length.

It has been found in accordance with the invention that the addition of such a protease to a liquid dishwashing detergent comprising an amylase gives a particularly storage-stable liquid dishwashing detergent, especially in terms of the remaining cleaning performance thereof after storage, especially after a storage time of, with increasing preference, 24 hours, 48 hours, 72 hours, 5 days, 1 week, 2 weeks, 3 weeks or 4 weeks.

A protease present in an inventive dishwashing detergent has proteolytic activity, meaning that it is able to hydrolyze peptide bonds of a polypeptide or protein. It is therefore an enzyme which catalyzes the hydrolysis of peptide bonds and is therefore able to cleave peptides or proteins. It is especially a subtilase and more preferably a subtilisin.

An amylase is an enzyme as described by way of introduction. For amylases, it is possible to use synonymous terms, for example 1,4-alpha-D-glucan glucanohydrolase or glycogenase. Amylases which can be formulated in accordance with the invention are preferably α-amylases. The crucial factor for whether an enzyme is an α-amylase in the context of the invention is the ability thereof to hydrolyze α(1-4)-glycoside bonds in the amylose of starch.

Amylases which can be formulated in accordance with the invention are, for example, the α-amylases from Bacillus licheniformis, from Bacillus amyloliquefaciens or from Bacillus stearothermophilus, and also, more particularly, the developments thereof which have been improved for use in washing or cleaning compositions and dishwashing detergents. The enzyme from Bacillus licheniformis is obtainable under the Termamyl® name from Novozymes, and under the Purastar®ST name from Danisco/Genencor. Development products of this α-amylase are obtainable under the Duramyl® and Termamyl®ultra trade names from Novozymes, under the Purastar®OxAm name from Danisco/Genencor, and as Keistase® from Daiwa Seiko Inc., Tokyo, Japan. The α-amylase from Bacillus amyloliquefaciens is sold under the BAN® name by Novozymes, and modified variants of the α-amylase from Bacillus stearothermophilus under the BSG® and Novamyl® names, likewise by Novozymes. In addition, the α-amylase from Bacillus sp. A 7-7 (DSM 12368) and the cyclodextrin glucanotransferase (CGTase) from Bacillus agaradherens (DSM 9948) should additionally be emphasized for this purpose. Likewise usable are fusion products of all the molecules mentioned. In addition, the developments of α-amylase from Aspergillus niger and A. oryzae obtainable under the Fungamyl® trade names from Novozymes are suitable. Further commercial products usable advantageously are, for example, Amylase-LT® and Stainzyme® or Stainzyme Ultra® or Stainzyme Plus®, the latter likewise from Novozymes. It is also possible in accordance with the invention to use variants of these enzymes obtainable by point mutations. Particularly preferred amylases are disclosed in international published specifications WO 00/60060, WO 03/002711, WO 03/054177 and WO07/079,938, the disclosure of which is therefore referred to explicitly, or the disclosure content of which in this regard is therefore incorporated explicitly into the present patent application.

Particularly suitable for use in the inventive compositions are α-amylase variants of the α-amylase AA560 according to SEQ ID NO. 3. The following variants are particularly advantageous:

(a) α-amylase variant which, compared to the α-amylase AA560 according to SEQ ID NO. 3, has one, two, three, four, five or six of the following sequence modifications in the listing of the α-amylase AA560: R118K, D183* (deletion), G184* (deletion), N195F, R320K, R458K. More preferably, the α-amylase variant has all six of the sequence modifications mentioned.

(b) α-amylase variant which, compared to the α-amylase AA560 according to SEQ ID NO. 3, has the following sequence modifications (in the listing of the α-amylase AA560):
(1) M9L/M2021,
(2) M9L/M2021/M323T,
(3) M9L/M2021/M323T/M382Y,
(4) M9L/M2021/Y295F/A339S,
(5) M9L/M2021/Y295F,
(6) M9L/M2021/A339S,
(7) M9L/M2021/Y295F/A339S,
(8) M9L/M2021/Y295F/A339S/E345R,
(9) M9L/G149A/M2021/Y295F/A339S/E345R,
(10) M9L/M202L,
(11) M9L/M202L/M323T,
(12) M9L/M202L/M323T/M382Y,
(13) M9L/M202L/Y295F/A339S,
(14) M9L/M202L/Y295F,
(15) M9L/M202L/A339S,
(16) M9L/M202L/Y295F/A339S,
(17) M9L/M202L/Y295F/A339S, E345R,
(18) M9L/G149A/M202L/Y295F/A339S/E345R,
(19) M9L/M202T,
(20) M9L/M202T/M323T,
(21) M9L/M202T/M323T/M382Y,
(22) M9L/M202T/Y295F/A339S,
(23) M9L/M202T/Y295F,
(24) M9L/M202T/A339S,
(25) M9L/M202T/Y295F/A339S,
(26) M9L/M202T/Y295F/A339S/E345R,
(27) M9L/G149A/M202T/Y295F/A339S/E345R,
(28) M9L/G149A/M2021/V214T/Y295F/N299Y/M323T/A339S/E345R,
(29) M9L/G149A/M202L/V214I/Y295F/M323T/A339S/E345R/M382Y,
(30) M9L/G149A/G182T/G186A/M2021/V214I/Y295F/N299Y/M323T/A339S,
(31) M9L/G149A/G182T/G186A/M202L/T2571/Y295F/N299Y/M323T/A339S/E345R,
(32) M9L/G149A/M202L/V214T/Y295F/N299Y/M323T/A339S/E345R,
(33) M9L/G149A/M2021/V214I/Y295F/M323T/A339S/E345R/M382Y,
(34) M9L/G149A/G182T/G186A/M202L/V2141/Y295F/N299Y/M323T/A339S,
(35) M9L/G149A/G182T/G186A/M2021/T257I/Y295F/N299Y/M323T/A339S/E345R,
(36) M9L/G149A/M2021/V214T/Y295F/N299Y/M323T/A339S/E345R/N471E,
(37) M9L/G149A/M202L/V214I/Y295F/M323T/A339S/E345R/M382Y/N471E,
(38) M9L/G149A/G182T/G186A/M2021/V214I/Y295F/N299Y/M323T/A339S/N471E,
(39) M9L/G149A/G182T/G186A/M202L/T2571/Y295F/N299Y/M323T/A339S/E345R/N471E,
(40) M202L/M105F/M208F,
(41) G133E/M202L/Q361E,
(42) G133E/M202L/R444E,
(43) M202L/Y295F,
(44) M202L/A339S,
(45) M202L/M323T,
(46) M202L/M323T/M309L,
(47) M202L/M323T/M4301,
(48) M202L/V214T/R444Y,
(49) M202L/N283D/Q361E,
(50) M202L/M382Y/K383R,
(51) M202L/K446R/N484Q,
(52) M2021/Y295F,
(53) M2021/A339S,
(54) M2021/M105F/M208F,
(55) G133E/M2021/Q361E,
(56) G133E/M2021/R444E,
(57) M2021/M323T,
(58) M2021/M323T/M309L,
(59) M2021/M323T/M430I,
(60) M2021/V214T/R444Y,
(61) M2021/N283D/Q361E,
(62) M2021/M382Y/K383R,
(63) M2021/K446R/N484Q,
(64) M202V/M105F/M208F,
(65) G133E/M202V/Q361E,
(66) G133E/M202V/R444E,
(67) M202V/M323T,
(68) M202V/M323T/M309L,
(69) M202V/M323T/M430I,
(70) M202V/M323T/M9L,
(71) M202V/V214T/R444Y,
(72) M202V/N283D/Q361E,
(73) M202V/M382Y/K383R,
(74) M202V/K446R/N484Q,
(75) M202T/M105F/M208F,
(76) G133E/M202T/Q361E,
(77) G133E/M202T/R444E,
(78) M202T/Y295F,
(79) M202T/A339S,
(80) M202T/M323T,
(81) M202T/M323T/M309L,
(82) M202T/M323T/M430I,
(83) M202T/M323T/M9L,
(84) M202T/V214T/R444Y,
(85) M202T/N283D/Q361E,
(86) M202T/A339S,
(87) M202T/Y295F
(88) M202T/N299F,Y,
(89) M202T/M382Y/K383R or
(90) M202T/K446R/N484Q

Among these, very particular preference is given to the following α-amylase variants:
(10) M9L/M202L,
(28) M9L/G149A/M2021/V214T/Y295F/N299Y/M323T/A339S/E345R,
(31) M9L/G149A/G182T/G186A/M202L/T2571/Y295F/N299Y/M323T/A339S/E345R,
(35) M9L/G149A/G182T/G186A/M2021/T257I/Y295F/N299Y/M323T/
(38) M9L/G149A/G182T/G186A/M2021/V214I/Y295F/N299Y/M323T/
(39) M9L/G149A/G182T/G186A/M202L/T2571/Y295F/N299Y/M323T/A339S/E345R/N471E,
(45) M202L/M323T,
(46) M202L/M323T/M309L,
(62) M2021/M382Y/K383R,
(68) M202V/M323T/M309L,
(73) M202V/M382Y/K383R
(82) M202T/M323T/M4301 or
(84) M202T/V214T/R444Y

(c) α-amylase variant according to (b) which additionally has all six sequence modifications mentioned under (a), and among these most preferably variant 31 with the six sequence modifications mentioned under (a).

Very particular preference is given in accordance with the invention to the α-amylase variant mentioned above under (a) and to the α-amylase variant 31 mentioned above under (c) with the six sequence modifications mentioned under (a).

The identity of nucleic acid or amino acid sequences is determined by a sequence alignment. Such an alignment is effected by assigning similar sequences in the nucleotide sequences or amino acid sequences to one another. This sequence alignment is preferably effected on the basis of the BLAST algorithm which is established in the prior art and is typically used (cf., for example, Altschul, S. F., Gish, W., Miller, W., Myers, E. W. & Lipman, D. J. (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, p. 3389-3402), and is accomplished in principle by assigning similar sequences of nucleotides or amino acids in the nucleic acid or amino acid sequences to one another. A tabular assignment of the positions in question is referred to as an alignment. A further algorithm available in the prior art is the FASTA algorithm. Sequence alignments, especially multiple sequence alignments, are typically produced with computer programs. Examples of frequently utilized computer programs are the Clustal series (cf., for example, Chema et al. (2003): Multiple sequence alignment with the Clustal series of programs. Nucleic Acid Research 31, 3497-3500), T-Coffee (cf., for example, Notredame et al. (2000): T-Coffee: A novel method for multiple sequence alignments. J. Mol. Biol. 302, 205-217), or programs based on these programs or algorithms. In the context of the present invention, sequence alignments are preferably produced with the Vector NTI® Suite 10.3 computer program (Invitrogen Corporation, 1600 Faraday Avenue, Carlsbad, Calif., USA) with the preset standard (default) parameters.

Such an alignment allows a statement as to the similarity of the sequences being compared with one another. It is typically reported in percent identity, i.e. the proportion of identical nucleotides or amino acid residues at the same positions or positions corresponding to one another in an alignment. The broader term of homology includes amino acid exchanges preserved in amino acid sequences in the consideration, i.e. amino acids having similar properties, since these usually exert similar activities or functions within the protein. Therefore, the similarity of the sequences being compared may also be reported percent homology or percent similarity. Identity and/or homology figures can be given over entire polypeptides or genes or only over individual regions. Homologous or identical regions of different nucleic acid or amino acid sequences are therefore defined by matches in the sequences. They often have identical or similar functions. They may be small and cover only a few nucleotides or amino acids. Often, such small regions exert essential functions for the overall activity of the protein. It may therefore be advisable to base sequence matches only on individual, possibly small regions. Unless stated otherwise, identity or homology figures given in the present application, however, relate to the entire length of the nucleic acid or amino acid sequence specified in each case.

In a further embodiment of the invention, it is a further characteristic feature of an inventive dishwashing detergent that its cleaning performance corresponds at least to that of a liquid dishwashing detergent comprising a protease according to SEQ ID NO. 2. The cleaning performance is determined in a washing system comprising an amylase-containing liquid dishwashing detergent in a dosage between 4.0 and 11.0 grams per liter of cleaning liquor and the protease, the proteases to be compared being used in the same concentration (based on active protein) and the cleaning performance being determined with respect to a minced meat and/or egg yolk stain on dishware by determining the remaining residue of the respective stain after the cleaning operation, the cleaning operation being effected for at least 30 minutes, preferably for 60 minutes, at a temperature of 50° C., and the water having a water hardness between 20 and 22° dH (German hardness), preferably 21° dH.

The dishwashing detergent for the washing system is preferably a biphasic liquid machine dishwashing detergent having the following composition (all figures in percent by weight):

(a) Enzyme phase:

### Builder 15.0-20.0

Sugar alcohol 8.0-12.0
Nonionic surfactant (C8-C10 fatty alcohol
ethoxylate with 22 EO) 3.0-5.0
Alkali metal compound (base) 3.0-4.0
Boric acid 2.5-3.5

### Phosphonate (HEDP) 1.5-2.5

### Amylase 1.0-2.0

Protease see text
Ca salt 0.8-1.2
Zn salt 0.15-0.25

### Thickener 0.8-1.2

Dye, perfume, preservative 0.25-0.5

### Water ad 100

The amylase is preferably the preparation of an α-amylase variant having the following sequence modifications in the listing of the α-amylase AA560 compared to the α-amylase AA560 according to SEQ ID NO. 3: R118K, D183* (deletion), G184* (deletion), N195F, R320K, R458K (from Novozymes).

(b) Alkaline phase:

### Builder 7.5-12.5

Sodium carbonate 7.5-12.5
Sulfo polymer 5.0-8.0
Alkali metal compound (base) 3.0-5.0

### Monoethanolamine 2.0-4.0

### Phosphonate (HEDP) 2.0-5.0

### Thickener 0.8-1.2

Dye, perfume, preservative 0.25-0.5

### Water ad 100

The protease is present in the composition in a concentration of 0.01-1% by weight, preferably of 0.1% to 0.5% by weight, based on active protein. For a wash cycle in a machine dishwasher, the two phases are dosed in equal portions (20 g of each phase). Washing is effected within a pH range between pH 9 and pH 10 in a standard machine dishwasher, for example a Miele G698SC machine dishwasher. Neither the protease activity nor the amylase activity in the cleaning liquor is zero on commencement of washing.

The cleaning performance is rated visually by the standard IKW method on a scale from 1 to 10, the value 10 being the best mark (no discernible residue).

Particular preference is given to determining the cleaning performance in a machine dishwasher with respect to a minced meat stain and an egg yolk stain on dishware using a biphasic liquid machine dishwashing detergent as described above.

In a further embodiment of the invention, it is a further characteristic feature of an inventive machine dishwashing detergent that its storage stability corresponds at least to that of a machine dishwashing detergent including a protease according to SEQ ID NO. 2. Such a storage stability exists when the inventive dishwashing detergent, after storage at 40° C. for four weeks, has a cleaning performance equal to or higher than the dishwashing detergent used for comparison, the inventive composition differing only by the protease present from the dishwashing detergent used as a comparison.

More preferably, the composition used for comparison is a biphasic liquid machine dishwashing detergent as specified above, the cleaning performance being determined as specified above.

On commencement of storage, the two compositions to be compared have the same amylolytic starting activity and comprise the protease in the same concentration based on active enzyme, and both compositions are treated in the same way. The proteolytic activity in the compositions is determined in each case via the release of the para-nitroaniline (pNA) chromophore from the suc-AAPF-pNA substrate, and the amylolytic activity of each is determined as specified above. The starting activities for the protease and the amylase in the respective composition are not equal to zero.

Through the use of the amylase with equal activity in each case and the use of the proteases with equal concentration, based on active protein, it is ensured that, even in the event of any divergence in the ratio of active substance to total protein (the values of the specific activity), the real enzymatic properties present are being compared.

Unless stated otherwise, in the context of the present invention, reference is made in each case to the weight of the liquid washing composition, i.e. the figures given are based on the weight thereof.

Numerous proteases and especially subtilisins take the form of what are called preproteins, i.e. are formed together with a propeptide and a signal peptide, the function of the signal peptide typically being to assure the discharge of the protease from the cell that produces it into the periplasma for the medium surrounding the cell, and the propeptide is typically needed for the correct folding of the protease. The signal peptide and the propeptide are generally the N-terminal portion of the preprotein. The signal peptide is cleaved off from the rest of the protease by a signal peptidase under natural conditions. This is followed by the correct final folding of the protease, supported by the propeptide. The protease is then in its active form and cleaves off the propeptide itself. After the propeptide has been cleaved off, the protease, which is then ripe (mature), especially subtilisin, exerts its catalytic activity without the originally present N-terminal amino acids. For industrial applications in general, and especially in the context of the invention, the ripe (mature) proteases, i.e. the enzymes processed after production thereof, are preferred over the preproteins. The proteases can also be modified by the cells that produce them after the production of the polypeptide chain, for example by attachment of sugar molecules, formylations, aminations, etc. Such modifications are post-translational modifications and can, but need not, exert an influence on the function of the protease.

In addition, the ripe protease can also be truncated at its N-terminal and/or C-terminal end, such that a protease truncated relative to SEQ ID NO. 1 or SEQ ID NO. 2, i.e. a fragment, is present in the inventive dishwashing detergent. All identity data in this case relate to that region in which the particular fragment is assigned in an SEQ ID NO. 1 alignment. The respective fragment, however, always includes the positions to be modified in accordance with the invention, i.e. positions assigned to positions 3, 4, 193, 199 and/or 211 in an alignment with SEQ ID NO. 1, and has corresponding modifications here as envisaged in accordance with the invention. Moreover, such a fragment is proteolytically active. A fragment which is further preferred in this regard comprises an amino acid sequence which corresponds over a length of at least 100 or at least 110, 120, 130, 140, 150, 160, 170, 180, 190, 200, 210, 220, 230, 240, 250, 260, 265 or 266 associated amino acid positions with SEQ ID NO. 1 or SEQ ID NO. 2, taking account of the aforementioned amino acids for position 211 and also for positions 3 and/or 4 and/or 193 and/or 199, and optionally also for positions 99 and/or 188. More preferably, the cleaning performance and/or storage stability of an inventive liquid dishwashing detergent comprising such a fragment corresponds at least to that of a dishwashing detergent including a protease comprising an amino acid sequence corresponding to the amino acid sequence specified in SEQ ID NO. 2, in each case determined as specified above.

An inventive composition comprises the protease, with increasing preference, in an amount of 1×10⁻⁸-5% by weight, of 0.0001-3% by weight, of 0.0005-1% by weight, of 0.001% to 0.75% by weight and more preferably of 0.005% to 0.5% by weight, based on active protein. An inventive composition comprises the amylase, with increasing preference, in an amount of 1×10⁻⁸-5% by weight, of 0.0001-3% by weight, of 0.0005-1% by weight, of 0.001% to 0.75% by weight and more preferably of 0.005% to 0.5% by weight, based on active protein. The protein concentration can be determined with the aid of known methods, for example the BCA method (bicinchonic acid; 2,2′-biquinolyl-4,4′-dicarboxylic acid) or the biuret method (A. G. Gornall, C. S. Bardawill and M.M. David, J. Biol. Chem., 177 (1948), p. 751-766). In this regard, the active protein concentration is determined via a titration of the active sites using a suitable irreversible inhibitor (for proteases, for example, phenylmethylsulfonyl fluoride (PMSF)) and determining the residual activity (cf. M. Bender et al., J. Am. Chem. Soc. 88, 24 (1966), p. 5890-5913).

The protease and/or the amylase may also be adsorbed on carrier substances and/or embedded in coating substances, in order to protect them from premature inactivation. In the cleaning liquor, i.e. under use conditions, the enzyme is then released and can display its catalytic action.

In a further embodiment of the invention, it is a further characteristic feature of the dishwashing detergent that it comprises a component selected from

i. anionic and/or polyanionic substance, and/or
ii. cationic and/or polycationic substance, and/or
iii. substance having hydroxyl group(s) and/or polyhydroxyl group(s).

It has been found that the addition of such substances further improves the cleaning performance of dishwashing detergents, especially of liquid dishwashing detergents comprising proteases and amylases, especially those as described above. Especially in combination with a protease for use in accordance with the invention, a synergistic effect occurs, particularly with regard to the removal of at least one protease-sensitive stain, especially one as specified above.

The substances specified above under i. are anionic or polyanionic substances, meaning that these substances bear at least one and preferably more than one negative charge. Preference is given to a polymer having at least one negatively charged monomer, preferably having a plurality of negatively charged monomers. Preferably in accordance with the invention, this polymer is therefore a negatively charged polymer. Preference is given, for example, to polymers of organic acids or salts thereof, especially polyacrylates and/or polysugar acids and/or polyacrylate copolymers and/or polysugar copolymers. Further preferred compounds in this regard are polyacryloylsulfonates or polycarboxylates, and the salts, copolymers or salts of the copolymers thereof.

Examples of substances for use with particular preference are Acusol 587D (polyacryloylsulfonate; from Rohm & Haas/Dow Chemical), Acusol 445N (polycarboxylate sodium salt; from Rohm & Haas/Dow Chemical), Acusol 590 (polyacrylate copolymer; from Rohm & Haas/Dow Chemical), Acusol 916 (polyacrylate sodium salt; from Rohm & Haas/Dow Chemical), Sokalan CP42 (modified polycarboxylate sodium salt; from BASF), Sokalan PA 30CL (polycarboxylate sodium salt; from BASF), Dequest P 9000 (polymaleic acid; from Thermphos), alginic acid, poly-2-acrylamido-2-methyl-1-propanesulfonic acid, poly-4-styrenesulfonic acid-co-maleic acid sodium salt, polyacrylamido-co-acrylic acid sodium salt, polymethacrylic acid sodium salt, poly(methyl vinyl ether)-alt-maleic acid or polyvinylsulfonic acid sodium salt.

The substances specified in ii. are cationic or polycationic substances, meaning that these substances bear at least one and preferably more than one positive charge. Preference is given to a polymer having at least one positively charged monomer, preferably having a plurality of positively charged monomers. Preferably in accordance with the invention, this polymer is therefore a positively charged polymer. Examples of compounds preferred in this regard are salts of the polyamines, polyethyleneimines or copolymers thereof, salts of the polyallylamines, salts of the polydiallyldimethylammonium compounds or poly(acrylamide-co-diallyldimethylammonium) compounds.

The substances specified in iii. are substances having at least one hydroxyl and/or polyhydroxyl group and preferably a plurality of hydroxyl and/or polyhydroxyl groups. Preference is given in this regard, for example, to polyvinyl alcohols, for example those available under the Mowiol trade name (from Kremer Pigmente GmbH & Co. KG).

It is explicitly pointed out here that a specific substance may belong to one or more of the aforementioned groups i. to iii. For example, a substance may be an anionic polymer having one or more hydroxyl and/or polyhydroxyl group(s). Such a substance then belongs to groups i. and iii. Equally, a cationic polymer having one or more hydroxyl and/or polyhydroxyl group(s) belongs to groups ii. and iii.

Likewise usable in the context of the present invention are derivatives of the substances mentioned above that belong to i., ii. or iii. A derivative in the context of the present application is understood to mean such a substance which, proceeding from one of the aforementioned substances, has been chemically modified, for example by the conversion of a side chain or by covalent bonding of another compound to the substance. Such a compound may comprise, for example, low molecular weight compounds such as lipids or mono-, oligo- or polysaccharides or amines or amine compounds. In addition, the compound may be glycosylated, hydrolyzed, oxidized, N-methylated, N-formylated, N-acetylated, or comprise methyl, formyl, ethyl, acetyl, t-butyl, anisyl, benzyl, trifluoroacetyl, N-hydroxysuccinimide, t-butyloxycarbonyl, benzoyl, 4-methyl benzyl, thioanisyl, thiocresyl, benzyloxymethyl, 4-nitrophenyl, benzyloxycarbonyl, 2-nitrobenzoyl, 2-nitrophenyl-sulfenyl, 4-toluenesulfonyl, pentafluorophenyl, diphenylmethyl, 2-chlorobenzyloxycarbonyl, 2,4,5-trichlorophenyl, 2-bromobenzyloxycarbonyl, 9-fluorenylmethyloxycarbonyl, triphenylmethyl, 2,2,5,7,8-pentamethylchromane-6-sulfonyl. A derivative is likewise understood to mean the covalent or noncovalent bond of the substance to a macromolecular carrier, and equally also to mean a noncovalent inclusion in suitable macromolecular cage structures. Couplings to other macromolecular compounds, for instance polyethylene glycol, can also be undertaken. Further preferred chemical modifications are the modification of one or more chemical groups —COOH, —OH, ═NH, —NH₂—SH to give —COOR, —OR, —NHR, —NR2, —NHR, —NR, —SR; where:

R is —CH═CH—R2, —C═C—R2, —C(R2)=CH₂, —C(R2)=C(R3), —CH═NR2, —C(R2)=N—R3, a 4-7 C-ring system with or without substitution, a 4-7 nitrogen heterocycle with or without substitution, or a C₂ to C₈ chain having 1 to 5 double or triple bonds having substitutions selected from R1, R2, or R3, where

—R1 is H, —R, —NO₂, —CN, halide substituent, —N₃, —C₁₋₈ alkyl, —(CH₂)n CO₂R2, —C2-8 alkenyl-CO₂R2, —O(CH₂)n CO₂R2, —C(O)NR2R3, —P(O)(OR2)₂, alkyl-substituted tetrazol-5-yl, —(CH₂)nO—(CH₂)n aryl, —NR2R3, —(CH₂)n OR2, —(CH₂)n SR2, —N(R2)C(O)R3, —S(O₂)NR2R3, —N(R2)S(O₂)R3, —(CHR2)n NR2R3, —C(O)R3, (CH₂)n N(R3)C(O)R3, —N(R2)CR2R3, substituted or unsubstituted (CH₂)n-cycloalkyl, substituted or unsubstituted (CH₂)n-phenyl, or -cycle; where n is a number greater than 1;

—R2 is H, halide substituent, -alkyl, -haloalkyl, —(CH₂)n-phenyl, —(CH₂)1-3-biphenyl, —(CH₂)1-4-Ph-N(SO₂—C1-2-alkyl)₂, —CO(CHR1)n-OR1, —(CHR1)n-heterocycle, —(CHR1)n-NH—CO—R1, —(CHR1)n-NH—SO₂R1, —(CHR1)n-Ph-N(SO₂—C₁₋₂-alkyl)₂, —(CHR1)n-C(O)(CHR1)-NHR1, —(CHR1)n-C(S)(CHR1)-NHR1, —(CH₂)n-O—(CH₂)nCH₃, —CF₃, acyl, —(CHR1)nOH, —(CHR1)nCO₂R1, —(CHR1)n-O-alkyl, —(CHR1)n-O—(CH₂)n-O-alkyl, —(CHR1)n-S-alkyl, —(CHR1)n-S(O)-alkyl, —(CHR1)n-S(O₂)-alkyl, —(CHR1)n-S(O₂)—NHR3, —(CHR3)n-N₃, —(CHR3)nNHR4, a C₂ to C₈ chain alkene chain having 1 to 5 double bonds, a C₂ to C₈ chain alkyne chain having 1 to 5 triple bonds, substituted or unsubstituted —(CHR3)n heterocycle, substituted or unsubstituted, saturated or unsaturated —(CHR3)n cycloalkyl; where n is a number greater than 1 and R1 and R3 may be the same or different;

—R3 is H, —OH, —CN, substituted alkyl, —C₂ to C₈ alkenyl, substituted or unsubstituted cycloalkyl, —N(R1)R2, saturated or unsaturated C₅ to C₇ heterocycle or heterobicycle of 4 to 7 carbon atoms, —NR1, —NR2, —NR1R2 consisting of a saturated or unsaturated heterocycle or a heterobicycle of 4 to 7 carbon atoms;

—R4 is H, —(CH₂)nOH, —C(O)OR5, —C(O)SR5, —(CH₂)nC(O)NR6R7, —O—C(O)—O—R6, an amino acid or a peptide, where n is a number from 0 to 4;

—R5 is H,

—R6 is —C(R7)-(CH₂)n-O—C(O)—R8, —(CH₂)n-C(R7)-O—C(O)R8, —(CH₂)n-C(R7)-O—C(O)—O—R8, or —C(R7)-(CH₂)n-O—C(O)—O—R8; where n is a number from 0 to 4; and

—R7 and R8 are each H, alkyl, substituted alkyl, aryl, substituted aryl, alkenyl, substituted alkenyl, alkynyl, substituted alkynyl, heterocycle, substituted heterocycle, alkylaryl, substituted alkylaryl, cycloalkyl, substituted cycloalkyl, or CH₂CO₂alkyl, where R7 and R8 may be the same or different.

It is also possible in accordance with the invention to use all possible combinations of the substances and/or derivatives thereof mentioned above as belonging to i., ii. or iii.

An inventive liquid dishwashing detergent can be used as such or after dilution with water for cleaning hard surfaces. Such a dilution can be prepared easily, by diluting a measured amount of the composition in a further amount of water in particular weight ratios of composition:water, and optionally shaking this dilution in order to ensure a homogeneous distribution of the composition in the water. Possible weight or volume ratios of the dilutions are from 1:0 composition:water to 1:10 000 or 1:20 000 composition:water, preferably from 1:10 to 1:2000 composition:water.

All liquid or free-flowing administration forms may serve here as liquid dishwashing detergents. “Free-flowing” compositions in the context of the present application are compositions which are pourable and have viscosities of the several tens of thousands of mPas. The viscosity can be measured by customary standard methods (for example Brookfield LVT-II viscometer at 20 rpm and 20° C., spindle 3) and is preferably in the range from 5 to 30 000 mPas. Preferred compositions have viscosities of 10 to 15 000 mPas, particular preference being given to values between 120 and 8000 mPas. A liquid dishwashing detergent in the context of the present invention may therefore also take the form of a gel or paste, or it may be present as a homogeneous solution or suspension or be formulated in other customary administration forms.

In a further embodiment of the invention, an inventive dishwashing detergent further comprises at least one further ingredient selected from the group consisting of builder, surfactant, anionic polymer and combinations thereof. In a further embodiment of the invention, an inventive dishwashing detergent is phosphate-free. Inventive phosphate-free dishwashing detergents are advantageous especially from an environmental point of view.

Preferably, the ingredients of the compositions are matched with respect to one another. Preference is given to synergies in terms of cleaning performance and/or rinse aid performance and/or scale inhibition. Particular preference is given to synergies present within a temperature range between 10° C. and 60° C., especially within a temperature range formi 20° C. to 55° C., from 25° C. to 50° C. and from 30° C. to 50° C.

The group of preferred builders includes especially the citrates and the carbonates, and the organic cobuilders. The term “citrate” likewise encompasses citric acid and the salts thereof, especially the alkali metal salts thereof. Particularly preferred inventive dishwashing detergents, especially machine dishwashing detergents, comprise citric acid and citrate, preferably sodium citrate, in amounts of 5% to 60% by weight, preferably 10% to 50% by weight and especially 15% to 40% by weight.

Particular preference is given to the use of carbonate(s) and/or hydrogencarbonate(s), preferably alkali metal carbonate(s), more preferably sodium carbonate, in amounts of 5% to 50% by weight, preferably of 10% to 40% by weight and especially of 15% to 30% by weight, based in each case on the weight of the dishwashing detergent.

Organic cobuilders include especially polycarboxylates/polycarboxylic acids and phosphonates. These substance classes are described below.

Usable organic builder substances are, for example, the polycarboxylic acids usable in the form of the free acid and/or sodium salts thereof, polycarboxylic acids being understood to mean those carboxylic acids which bear more than one acid function. Examples of these are adipic acid, succinic acid, glutaric acid, malic acid, tartaric acid, maleic acid, fumaric acid, sugar acids, aminocarboxylic acids, nitrilotriacetic acid (NTA) and mixtures of these. The free acids have, as well as their builder action, typically also the property of an acidifying component and hence also serve to establish a lower and milder pH of inventive compositions. Particular mention should be made in this context of succinic acid, glutaric acid, adipic acid, gluconic acid and any desired mixtures of these.

The complex-forming phosphates include, as well as 1-hydroxyethane-1,1-diphosphonic acid, a series of different compounds, for example diethylenetriaminepenta(methylenephosphonic acid) (DTPMP). In this application, preference is given especially to hydroxyalkane- or aminoalkane-phosphonates. Among the hydroxyalkanephosphonates, 1-hydroxyethane-1,1-diphosphonate (HEDP) is of particular significance as a cobuilder. It is preferably used in the form of the sodium salt, the disodium salt being neutral and the tetrasodium salt alkaline (pH 9). Useful aminoalkane-phosphonates preferably include ethylenediaminetetramethylenephosphonate (EDTMP), diethylenetriaminepentamethylene-phosphonate (DTPMP) and the higher homologs thereof. They are preferably used in the form of the neutral sodium salts, for example as the hexasodium salt of EDTMP or as the hepta- and octasodium salt of DTPMP. The builder used from the class of the phosphonates is preferably HEDP. The aminoalkanephosphonates additionally have marked heavy-metal binding capacity. Accordingly, especially when the compositions also comprise bleaches, it may be preferable to use aminoalkanephosphonates, especially DTPMP, or mixtures of the phosphonates mentioned.

A dishwashing detergent, especially machine dishwashing detergent, preferred in the context of this application, comprises one or more phosphonate(s) from the group of
a) aminotrimethylenephosphonic acid (ATMP) and/or salts thereof;
b) ethylenediaminetetra(methylenephosphonic acid) (EDTMP) and/or salts thereof;
c) diethylenetriaminepenta(methylenephosphonic acid) (DTPMP) and/or salts thereof;
d) 1-hydroxyethane-1,1-diphosphonic acid (HEDP) and/or salts thereof;
e) 2-phosphonobutane-1,2,4-tricarboxylic acid (PBTC) and/or salts thereof;
f) hexamethylenediaminetetra(methylenephosphonic acid) (HDTMP) and/or salts thereof;
g) nitrilotri(methylenephosphonic acid) (NTMP) and/or salts thereof.

Particular preference is given to machine dishwashing detergents comprising, as phosphonates, 1-hydroxyethane-1,1-diphosphonic acid (HEDP) or diethylenetriaminepenta(methylenephosphonic acid) (DTPMP).

In addition, the inventive dishwashing detergents, especially machine dishwashing detergents, may comprise two or more different phosphonates.

The proportion by weight of the phosphonates in the total weight of inventive dishwashing detergents, especially machine dishwashing detergents, is preferably 1% to 8% by weight, more preferably 1.2% to 6% by weight and especially 1.5% to 4% by weight.

Inventive dishwashing detergents, especially machine dishwashing detergents, may comprise one surfactant or a plurality of surfactants, in which case particularly anionic surfactants, nonionic surfactants and mixtures thereof are useful.

Among the anionic surfactants, preference is given to those having at least one sulfate or sulfonate group. The anionic surfactant having at least one sulfate or sulfonate group is preferably selected from fatty alcohol sulfates, alkanesulfonates and alkylbenzenesulfonates. Preference is given here to C₁₂-C₁₈ fatty alcohol sulfates (FAS), e.g. Sulfopon K 35 (Cognis, Germany), secondary C₁₃-C₁₇-alkanesulfonates (SAS), e.g. Hostapur SAS 93 (Clariant, Germany), and linear C8-C18-alkylbenzenesulfonates, especially dodecyl benzenesulfonate (LAS).

According to the invention, the terms “sulfate” and “sulfonate” encompass not only the relevant anionic compounds present in the form of salts but also the free acids, i.e. the corresponding alkylsulfuric acids or alkylsulfonic acids.

Preferably, the anionic surfactant having at least one sulfate or sulfonate group is present in inventive dishwashing detergents in an amount of 0.1% to 20% by weight, more preferably 0.5% to 15% by weight, especially 2.5% to 10% by weight.

Nonionic surfactants used may be any of the nonionic surfactants known to those skilled in the art. Suitable nonionic surfactants are, for example, alkyl glycosides of the general formula RO(G)ₓ in which R is a primary straight-chain or methyl-branched, especially 2-methyl-branched, aliphatic radical having 8 to 22 and preferably 12 to 18 carbon atoms, and G is the symbol that represents a glycose unit having 5 or 6 carbon atoms, preferably glucose. The oligomerization level x, which states the distribution of monoglycosides and oligoglycosides, is any number between 1 and 10; preferably, x is 1.2 to 1.4.

A further class of nonionic surfactants used with preference, which are used either as the sole nonionic surfactant or in combination with other nonionic surfactants, are alkoxylated, preferably ethoxylated or ethoxylated and propoxylated, fatty acid alkyl esters, preferably having 1 to 4 carbon atoms in the alkyl chain.

Other suitable nonionic surfactants may be those of the amine oxide type, for example N-cocoalkyl-N,N-dimethylamine oxide and N-tallowalkyl-N,N-dihydroxyethylamine oxide, and of the fatty acid alkanolamide type. The amount of these nonionic surfactants is preferably not more than that of the ethoxylated fatty alcohols, especially not more than half thereof.

Further suitable surfactants are polyhydroxy fatty acid amides of the formula

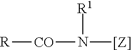

in which R is an aliphatic acyl radical having 6 to 22 carbon atoms, R¹ is hydrogen or an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which can typically be obtained by reductive amination of a reducing sugar with ammonia, an alkylamine or an alkanolamine and subsequent acylation with a fatty acid, a fatty acid alkyl ester or a fatty acid chloride.

The group of the polyhydroxy fatty acid amides also includes compounds of the formula

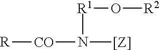

in which R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or a hydroxyalkyl radical having 1 to 8 carbon atoms, preference being given to C₁₋₄-alkyl or phenyl radicals, and [Z] is a linear polyhydroxyalkyl radical wherein the alkyl chain is substituted by at least two hydroxyl groups, or alkoxylated, preferably ethoxylated or propoxylated, derivatives of this radical.

[Z] is preferably obtained by reductive amination of a reducing sugar, for example glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as catalyst.

Preferred surfactants used are low-foaming nonionic surfactants. With particular preference, washing or cleaning compositions, especially cleaning compositions for machine dishwashing and among these preferably machine dishwashing, comprise nonionic surfactants from the group of the alkoxylated alcohols. Nonionic surfactants used are preferably alkoxylated, advantageously ethoxylated, especially primary alcohols having preferably 8 to 18 carbon atoms and an average of 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates are those which have linear radicals of alcohols of native origin having 12 to 18 carbon atoms, for example of coconut, palm, tallow fat or oleyl alcohol, and an average of 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

With particular preference, therefore, ethoxylated nonionic surfactants which have been obtained from C₆₋₂₀-monohydroxyalkanols or C₆₋₂₀-alkylphenols or C₁₆₋₂₀-fatty alcohols and more than 12 mol, preferably more than 15 mol and especially more than 20 mol of ethylene oxide per mole of alcohol are used. A particularly preferred nonionic surfactant is obtained from a straight-chain fatty alcohol having from 16 to 20 carbon atoms (C₁₆₋₂₀-alcohol), preferably a C₁₈-alcohol, and at least 12 mol, preferably at least 15 mol and in particular at least 20 mol, of ethylene oxide. Of these, the “narrow range ethoxylates” are particularly preferred.

With particular preference, moreover, surfactants which contain one or more tallow fat alcohols with 20 to 30 EO in combination with a silicone defoamer are used.

Special preference is given to nonionic surfactants which have a melting point above room temperature. Particular preference is given to nonionic surfactant(s) having a melting point above 20° C., preferably above 25° C., more preferably between 25 and 60° C. and especially between 26.6 and 43.3° C.

Suitable nonionic surfactants which have melting or softening points in the temperature range specified are, for example, low-foaming nonionic surfactants which may be solid or highly viscous at room temperature. When nonionic surfactants of high viscosity at room temperature are used, they preferably have a viscosity above 20 Pa·s, preferably above 35 Pa·s and in particular above 40 Pa·s. Nonionic surfactants having a waxlike consistency at room temperature are also preferred.

Nonionic surfactants from the group of the alkoxylated alcohols, more preferably from the group of the mixed alkoxylated alcohols and especially from the group of the EO-AO-EO nonionic surfactants, are likewise used with particular preference.

The room temperature solid nonionic surfactant preferably has propylene oxide units in the molecule. Preferably, such PO units make up up to 25% by weight, more preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably makes up more than 30% by weight, more preferably more than 50% by weight and in particular more than 70% by weight, of the total molar mass of such nonionic surfactants. Preferred compositions are characterized in that they comprise ethoxylated and propoxylated nonionic surfactants in which the propylene oxide units in the molecule make up up to 25% by weight, preferably up to 20% by weight and in particular up to 15% by weight, of the total molar mass of the nonionic surfactant.

Surfactants for use with preference come from the groups of alkoxylated nonionic surfactants, especially the ethoxylated primary alcohols and mixtures of these surfactants with structurally complex surfactants, such as polyoxypropylene/polyoxyethylene/polyoxypropylene ((PO/EO/PO) surfactants). Such (PO/EO/PO) nonionic surfactants are additionally notable for good foam control.

Further nonionic surfactants with melting points above room temperature for use with particular preference contain 40% to 70% of a polyoxypropylene/polyoxyethylene/polyoxypropylene block polymer blend which contains 75% by weight of an inverse block copolymer of polyoxyethylene and polyoxypropylene having 17 mol of ethylene oxide and 44 mol of propylene oxide, and 25% by weight of a block copolymer of polyoxyethylene and polyoxypropylene initiated with trimethylolpropane and containing 24 mol of ethylene oxide and 99 mol of propylene oxide per mole of trimethylolpropane.

Particularly preferred nonionic surfactants in the context of the present invention have been found to be low-foaming nonionic surfactants having alternating ethylene oxide and alkylene oxide units. Among these, preference is given in turn to surfactants having EO-AO-EO-AO blocks, where one to ten EO or AO groups are bonded to one another before a block of the other groups in each case follows. Preference is given here to nonionic surfactants of the general formula

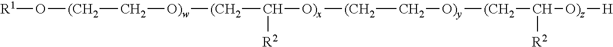

in which R¹ is a straight-chain or branched, saturated or mono- or polyunsaturated C₆₋₂₄-alkyl or -alkenyl radical; each R² or R³ group is independently selected from —CH₃, —CH₂CH₃, —CH₂CH₂—CH₃, CH(CH₃)₂ and the indices w, x, y, z are each independently integers from 1 to 6.

The preferred nonionic surfactants of the above formula can be prepared by known methods from the corresponding alcohols R¹—OH and ethylene oxide or alkylene oxide. The R¹ radical in the above formula may vary depending on the origin of the alcohol. When native sources are utilized, the R¹ radical has an even number of carbon atoms and is generally unbranched, and preference is given to the linear radicals of alcohols of native origin having 12 to 18 carbon atoms, for example from coconut, palm, tallow fat or oleyl alcohol. Alcohols obtainable from synthetic sources are, for example, the Guerbet alcohols or 2-methyl-branched or linear and methyl-branched radicals in a mixture, as are typically present in oxo alcohol radicals. Irrespective of the type of the alcohol used to prepare the nonionic surfactants present in the compositions, preference is given to nonionic surfactants in which R¹ in the above formula is an alkyl radical having 6 to 24, preferably 8 to 20, more preferably 9 to 15 and especially 9 to 11 carbon atoms.

An alkylene oxide unit which is present in the preferred nonionic surfactants in alternation with the ethylene oxide unit is, as well as propylene oxide, especially butylene oxide. However, further alkylene oxides in which R² and R³ are each independently selected from —CH₂CH₂—CH₃ and CH(CH₃)₂ are also suitable. Preference is given to using nonionic surfactants of the above formula in which R² and R³ are each a —CH₃ radical, w and x are each independently 3 or 4, and y and z are each independently 1 or 2.

In summary, preference is given in particular to nonionic surfactants which have a C₉₋₁₅-alkyl radical having 1 to 4 ethylene oxide units, followed by 1 to 4 propylene oxide units, followed by 1 to 4 ethylene oxide units, followed by 1 to 4 propylene oxide units. In aqueous solution, these surfactants have the required low viscosity and can be used with particular preference in accordance with the invention.

Preference is given in accordance with the invention to surfactants of the general formula

R¹—CH(OH)CH₂O-(AO)_{w}-(A′O)ₓ-(A″O)_{y}-(A′″O)_{z}—R² in which

R¹ and R² are each independently a straight-chain or branched, saturated or mono- or polyunsaturated C₂₋₄₀-alkyl or -alkenyl radical; A, A′, A″ and A′″ are each independently a radical selected from the group of —CH₂CH₂, —CH₂CH₂—CH₂, —CH₂CH(CH₃), —CH₂—CH₂—CH₂—CH₂, —CH₂—CH(CH₃)—CH₂, —CH₂—CH(CH₂—CH₃); and w, x, y, z are each values from 0.5 to 90, where x, y and/or z may also be 0.

Very particular preference is given here to nonionic surfactants of the general formula R¹O[CH₂CH(CH₃)O]ₓ[CH₂CH₂O]_{y}[CH₂CH(CH₃)O]_{z}CH₂CH(OH)R² in which R¹ is a linear or branched aliphatic hydrocarbyl radical having 4 to 22, especially 6 to 18, carbon atoms or mixtures thereof, R² denotes a linear or branched hydrocarbyl radical having 2 to 26, especially 4 to 20, carbon atoms or mixtures thereof, and x and z are values between 0 and 40 and y is a value of at least 15, preferably of 15 to 120, more preferably of 20 to 80.

In a preferred embodiment, the dishwashing detergent, especially the machine dishwashing detergent, based on the total weight thereof, comprises nonionic surfactant of the general formula R¹O[CH₂CH(CH₃)O]ₓ[CH₂CH₂O]_{y}[CH₂CH(CH₃)O]_{z}CH₂CH(OH)R² in amounts of 0.1% to 15% by weight, preferably 0.2% to 10% by weight, more preferably 0.5% to 8% by weight and especially of 1.0% to 6% by weight.

Preference is given especially to those end group-capped poly(oxyalkylated) nonionic surfactants of the formula R¹O[CH₂CH₂O]_{y}CH₂CH(OH)R² in which R¹ is a linear or branched aliphatic hydrocarbyl radical having 4 to 22, especially 6 to 16, carbon atoms or mixtures thereof, R² denotes a linear or branched hydrocarbyl radical having 2 to 26, especially 4 to 20, carbon atoms or mixtures thereof and y is a value between 15 and 120, preferably 20 to 100, especially 20 to 80. The group of these nonionic surfactants includes, for example, hydroxy mixed ethers of the general formula C₆₋₂₂—CH(OH)CH₂O-(EI)₂₀₋₁₂₀-C₂₋₂₆, for example the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

Particular preference is given to inventive dishwashing detergents, especially machine dishwashing detergents, wherein the low-foaming nonionic surfactant used is a surfactant of the general formula R¹CH(OH)CH₂O—(CH₂CH₂O)₂₀₋₁₂₀—R² where R¹ and R² are each independently a linear or branched aliphatic hydrocarbyl radical having 2 to 20, especially 4 to 16, carbon atoms.

Preference is further given to surfactants of the formula

R¹O[CH₂CH(CH₃)O]ₓ[CH₂CH₂O]_{y}CH₂CH(OH)R² in which R¹ is a linear or branched aliphatic hydrocarbyl radical having 4 to 22 carbon atoms or mixtures thereof, R² denotes a linear or branched hydrocarbyl radical having 2 to 26 carbon atoms or mixtures thereof and x represents values between 0.5 and 4, preferably 0.5 to 1.5, and y is a value of at least 15.

According to the invention, preference is additionally also given to surfactants of the general formula R¹O[CH₂CH(CH₃)O]ₓ[CH₂CH₂O]_{y}CH₂CH(OH)R² in which R¹ is a linear or branched aliphatic hydrocarbyl radical having 4 to 22 carbon atoms or mixtures thereof, R² denotes a linear or branched hydrocarbyl radical having 2 to 26 carbon atoms or mixtures thereof and x is a value between 1 and 40 and y is a value between 15 and 40, where the alkylene units [CH₂CH(CH₃)O] and [CH₂CH₂O] are randomized, i.e. are in the form of a statistical, random distribution.

The group of the preferred end group-capped poly(oxyalkylated) nonionic surfactants also includes nonionic surfactants of the formula R¹O[CH₂CH₂O]ₓ[CH₂CH(R³)O]_{y}CH₂CH(OH)R² in which R¹ and R² are each independently a linear or branched, saturated or mono- or polyunsaturated hydrocarbyl radical having 2 to 26 carbon atoms, R³ is independently selected from —CH₃, —CH₂CH₃, —CH₂CH₂—CH₃, —CH(CH₃)₂, but is preferably —CH₃, and x and y are each independently values between 1 and 32, very particular preference being given to nonionic surfactants with R³=—CH₃ and values of x of 15 to 32 and y of 0.5 and 1.5.

Further nonionic surfactants usable with preference are the end group-capped poly(oxyalkylated) nonionic surfactants of the formula

R¹O[CH₂CH(R³)O]ₓ[CH₂]ₖCH(OH)[CH₂]ᵢOR²

in which R¹ and R² are linear or branched, saturated or unsaturated, aliphatic or aromatic hydrocarbyl radicals having 1 to 30 carbon atoms, R³ is H or a methyl, ethyl, n-propyl, isopropyl, n-butyl, 2-butyl or 2-methyl-2-butyl radical, x represents values between 1 and 30, k and j represent values between 1 and 12, preferably between 1 and 5. If the value x≧2, every R³ in the above formula R¹O[CH₂CH(R³)O]ₓ[CH₂]ₖCH(OH)[CH₂]ᵢOR² may be different. R¹ and R² are preferably linear or branched, saturated or unsaturated, aliphatic or aromatic hydrocarbyl radicals having 6 to 22 carbon atoms, particular preference being given to radicals having 8 to 18 carbon atoms. For the R³ radical, particular preference is given to H, —CH₃ or —CH₂CH₃. Particularly preferred values of x are in the range from 1 to 20, especially from 6 to 15.

As described above, every R³ in the above formula may be different if x 2. As a result of this, the alkylene oxide unit in the square brackets may be varied. If x, for example, is 3, the R³ radical may be selected in order to form ethylene oxide (R³═H) or propylene oxide (R³═CH₃) units, which may be joined to one another in any sequence, for example (EO)(PO)(EO), (EO)(EO)(PO), (EO)(EO)(EO), (PO)(EO)(PO), (PO)(PO)(EO) and (PO)(PO)(PO). The value of 3 for x has been selected here by way of example and may quite possibly be greater, with an increasing range of variation with rising x values, including, for example, a large number of (EO) groups combined with a small number of (PO) groups, or vice versa.

Particularly preferred end group-capped poly(oxyalkylated) alcohols of the above formula have values of k=1 and j=1, such that the above formula is simplified to R¹O[CH₂CH(R³)O]ₓCH₂CH(OH)CH₂OR².

In the latter formula, R¹, R² and R³ are each as defined above and x represents numbers from 1 to 30, preferably from 1 to 20 and especially from 6 to 18. Particular preference is given to surfactants in which the R¹ and R² radicals have 9 to 14 carbon atoms, R³ is H and x assumes values from 6 to 15.

Further nonionic surfactants used with preference are nonionic surfactants of the general formula R¹O(AlkO)ₓM(OAlk)_{y}OR² where

R¹ and R² are each independently a branched or unbranched, saturated or unsaturated, optionally hydroxylated alkyl radical having 4 to 22 carbon atoms;

Alk is a branched or unbranched alkyl radical having 2 to 4 carbon atoms;

x and y are each independently values between 1 and 70; and

M is an alkyl radical from the group of CH₂, CHR³, CR³R⁴, CH₂CHR³ and CHR³CHR⁴, where R³ and R⁴ are each independently a branched or unbranched, saturated or unsaturated alkyl radical having 1 to 18 carbon atoms.

Preference is given here to nonionic surfactants of the general formula

R¹—CH(OH)CH₂—O(CH₂CH₂O)_{X}CH₂CHR(OCH₂CH₂)_{y}O—CH₂CH(OH)—R² where
R, R¹ and R² are each independently an alkyl radical or alkenyl radical having 6 to 22 carbon atoms;
x and y are each independently values between 1 and 40.

Preference is given here especially to compounds of the general formula R¹—CH(OH)CH₂—O(CH₂CH₂O)ₓCH₂CHR(OCH₂CH₂)_{y}O—CH₂CH(OH)—R² in which R is a linear, saturated alkyl radical having 8 to 16 carbon atoms, preferably 10 to 14 carbon atoms, and n and m each independently have values of 20 to 30. Corresponding compounds can be obtained, for example, by reaction of alkyl diols HO—CHR—CH₂—OH with ethylene oxide, with subsequent reaction with an alkyl epoxide to cap the free OH functions to form a dihydroxylether.

In a further preferred embodiment, the nonionic surfactant is selected from nonionic surfactants of the general formula

R¹—O(CH₂CH₂O)ₓCR³R⁴(OCH₂CH₂)_{y}O—R² in which
R¹ and R² are each independently an alkyl radical or alkenyl radical having 4 to 22 carbon atoms;
R³ and R⁴ are each independently H or an alkyl radical or alkenyl radical having 1 to 18 carbon atoms and
x and y are each independently values between 1 and 40.

Preference is given here especially to compounds of the general formula R¹—O(CH₂CH₂O)ₓCR³R⁴(OCH₂CH₂)_{y}O—R² in which R³ and R⁴ are each H and the indices x and y each independently assume values from 1 to 40, preferably from 1 to 15.

Particular preference is given especially to compounds of the general formula R¹—O(CH₂CH₂O)ₓCR³R⁴(OCH₂CH₂)_{y}O—R² in which the R¹ and R² radicals are each independently saturated alkyl radicals having 4 to 14 carbon atoms and the indices x and y each independently assume values of 1 to 15 and especially of 1 to 12.

Preference is further given to those compounds of the general formula R¹—O(CH₂CH₂O)ₓCR³R⁴(OCH₂CH₂)_{y}O—R² in which one of the R¹ and R² radicals is branched.

Very particular preference is given to compounds of the general formula R¹—O(CH₂CH₂O)ₓCR³R⁴(OCH₂CH₂)_{y}O—R² in which the indices x and y each independently assume values from 8 to 12.

The stated carbon chain lengths and ethoxylation levels or alkoxylation levels of the aforementioned nonionic surfactants are statistical mean values which may be a whole number or a fraction for a specific product. Because of the production processes, commercial products of the formula mentioned do not usually consist of an individual representative, but of mixtures, as a result of which mean values and, as a consequence of this, fractions may arise both for the carbon chain lengths and for the ethoxylation levels or alkoxylation levels.

Of course, the aforementioned nonionic surfactants can be used not just as single substances but also as surfactant mixtures of two, three, four or more surfactants. Surfactant mixtures do not refer to mixtures of the nonionic surfactants which, in their entirety, are covered by one of the above-mentioned general formulae, but instead to those mixtures comprising two, three, four or more surfactants which can be described by different general formulae from those above.

Especially preferred are those nonionic surfactants having a melting point above room temperature. Particular preference is given to nonionic surfactant(s) having a melting point above 20° C., preferably above 25° C., more preferably between 25 and 60° C. and especially between 26.6 and 43.3° C.

The proportion by weight of the nonionic surfactant in the total weight of the inventive dishwashing detergent, especially machine dishwashing detergent, in a preferred embodiment, is from 0.1% to 20% by weight, more preferably from 0.5% to 15% by weight, especially from 2.5% to 10% by weight.

In a preferred embodiment, the % by weight ratio of anionic surfactant having at least one sulfate or sulfonate group to nonionic surfactant is from 3:1 to 1:3, especially from 2:1 to 1:2, more preferably from 1.5:1 to 1:1.5.

Inventive dishwashing detergents, especially machine dishwashing detergents, comprise, as a further constituent, in a preferred embodiment, at least one anionic polymer. Preferred anionic polymers here are the copolymeric polycarboxylates and the copolymeric polysulfonates.

The proportion by weight of anionic polymer in the total weight of the inventive dishwashing detergent, especially machine dishwashing detergent, in a preferred embodiment, is from 0.1% to 20% by weight, preferably from 0.5% to 18% by weight, more preferably from 1.0% to 15% by weight and especially from 4% to 14% by weight.

Inventive dishwashing detergents, especially machine dishwashing detergents, wherein the copolymeric anionic polymer is selected from the group of the hydrophobically modified polycarboxylates and polysulfonates forms a particularly preferred part of the subject matter of the present invention, since the hydrophobic modification of the anionic copolymers can achieve an improvement in the rinse aid properties and drying properties of these compositions, combined with simultaneously low scale formation.

The copolymers may have two, three, four or more different monomer units.

Preferred copolymeric polysulfonates comprise, as well as monomer(s) containing sulfo groups, at least one monomer from the group of the unsaturated carboxylic acids.

Unsaturated carboxylic acid(s) used with particular preference is/are unsaturated carboxylic acids of the formula R¹(R²)C═C(R³)COOH in which R¹ to R³ are each independently —H, —CH₃, a straight-chain or branched saturated alkyl radical having 2 to 12 carbon atoms, a straight-chain or branched, mono- or polyunsaturated alkenyl radical having 2 to 12 carbon atoms, —NH₂—, —OH— or —COOH-substituted alkyl or alkenyl radicals as defined above, or —COOH or —COOR⁴ where R⁴ is a saturated or unsaturated, straight-chain or branched hydrocarbyl radical having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylenemalonic acid, sorbic acid, cinnamic acid or mixtures thereof. It is of course also possible to use the unsaturated dicarboxylic acids.

Copolymeric polycarboxylates used in accordance with the invention are more preferably copolymers of acrylic acid with methacrylic acid and of acrylic acid or methacrylic acid with maleic acid. Particularly suitable copolymers have been found to be those of acrylic acid with maleic acid comprising 50% to 90% by weight of acrylic acid and 50% to 10% by weight of maleic acid. The relative molecular mass thereof, based on free acids, is generally 2000 to 70 000 g/mol, preferably 20 000 to 50 000 g/mol and especially 30 000 to 40 000 g/mol.

The molar masses reported in the context of this document are weight-average molar masses Mw, which were always determined by means of gel permeation chromatography (GPC) using a UV detector. The measurement was effected against an external standard which, because of its structural relationship with the polymers being examined, gives realistic molar mass values.

Preferred monomers containing sulfo groups are those of the formula

R⁵(R⁶)C═C(R⁷)—X—SO₃H

in which R⁵ to R⁷ are each independently —H, —CH₃, a straight-chain or branched saturated alkyl radical having 2 to 12 carbon atoms, a straight-chain or branched, mono- or polyunsaturated alkenyl radical having 2 to 12 carbon atoms, —NH₂—, —OH— or —COOH-substituted alkyl or alkenyl radicals, or —COOH or —COOR⁴ where R⁴ is a saturated or unsaturated, straight-chain or branched hydrocarbyl radical having 1 to 12 carbon atoms, and X is an optionally present spacer group selected from —(CH₂)ₙ— with n=0 to 4, —COO—(CH₂)ₖ— with k=1 to 6, —C(O)—NH—C(CH₃)₂—, —C(O)—NH—C(CH₃)₂—CH₂— and —C(O)—NH—CH(CH₃)—CH₂—.

Among these monomers, preference is given to those of the formulae

H₂C═CH—X—SO₃H

H₂C═C(CH₃)—X—SO₃H

HO₃S—X—(R⁶)C═C(R⁷)—X—SO₃H,

in which R⁶ and R⁷ are each independently selected from —H, —CH₃, —CH₂CH₃, —CH₂CH₂CH₃ and —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂—, —C(O)—NH—C(CH₃)₂—CH₂— and —C(O)—NH—CH(CH₃)—CH₂—.

Particularly preferred monomers containing sulfo groups here are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzene-sulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and mixtures of the acids mentioned or the water-soluble salts thereof.

In the polymers, the sulfo groups may be fully or partly in neutralized form, meaning that the acidic hydrogen atom of the sulfo group in some or all sulfo groups may be exchanged for metal ions, preferably alkali metal ions, and especially for sodium ions. The use of partly or fully neutralized copolymers containing sulfo groups is preferred in accordance with the invention.

The monomer distribution of the copolymers for use with preference in accordance with the invention, in the case of copolymers comprising only monomers containing carboxyl groups and monomers containing sulfo groups, is preferably 5% and 95% by weight in each case; more preferably, the proportion of the monomer containing sulfo groups is 50% to 90% by weight and the proportion of the monomer containing carboxyl groups is 10% to 50% by weight, the monomers here preferably being selected from those mentioned above.

The molar mass of the sulfo copolymers used with preference in accordance with the invention may be varied in order to match the properties of the polymers to the desired end use. It is a characteristic feature of preferred dishwashing detergents, especially machine dishwashing detergents, that the copolymers have molar masses of 2000 to 200 000 gmol⁻¹, preferably of 4000 to 25 000 gmol⁻¹ and especially of 5000 to 15 000 gmol⁻¹.

In a further preferred embodiment, the copolymers comprise, as well as monomers containing carboxyl groups and monomers containing sulfo groups, additionally at least one nonionic, preferably hydrophobic monomer. Through the use of these hydrophobically modified polymers, it was especially possible to improve the rinse aid performance of inventive machine dishwashing detergents.

Preference is given in accordance with the invention to dishwashing detergents, especially machine dishwashing detergents, wherein the dishwashing detergent comprises, as anionic copolymer, a copolymer comprising
i) monomer(s) containing carboxyl groups
ii) monomer(s) containing sulfo groups
iii) nonionic monomer(s).

Nonionic monomers used are preferably monomers of the general formula R¹(R²)C═C(R³)—X—R⁴ in which R¹ to R³ are each independently —H, —CH or —C₂H₅, X is an optionally present spacer group selected from —CH₂—, —C(O)O— and —C(O)—NH—, and R⁴ is a straight-chain or branched saturated alkyl radical having 2 to 22 carbon atoms or is an unsaturated, preferably aromatic, radical having 6 to 22 carbon atoms.

Particularly preferred nonionic monomers are butene, isobutene, pentene, 3-methylbutene, 2-methylbutene, cyclopentene, hexene, hex-1-ene, 2-methylpent-1-ene, 3-methylpent-1-ene, cyclohexene, methylcyclopentene, cycloheptene, methylcyclohexene, 2,4,4-trimethylpent-1-ene, 2,4,4-trimethylpent-2-ene, 2,3-dimethylhex-1-ene, 2,4-dimethylhex-1-ene, 2,5-dimethylhex-1-ene, 3,5-dimethylhex-1-ene, 4,4-dimethylhex-1-ane, ethylcyclohexyne, 1-octene, α-olefins having 10 or more carbon atoms, for example 1-decene, 1-dodecene, 1-hexadecene, 1-octadecene and C22-α-olefin, 2-styrene, α-methylstyrene, 3-methylstyrene, 4-propylstyrene, 4-cyclohexylstyrene, 4-dodecylstyrene, 2 ethyl-4-benzylstyrene, 1-vinyl naphthalene, 2-vinyl naphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acryl amide or mixtures thereof.

In a further embodiment of the invention, it is a characteristic feature of an inventive dishwashing detergent that it comprises at least one further enzyme, especially a protease, amylase, cellulase, pectin-cleaving enzyme, hemicellulase, mannanase, tannase, xylanase, xanthanase, β-glucosidase, carrageenase, perhydrolase, oxidase, oxidoreductase or a lipase, and combinations thereof, especially a combination selected from protease and amylase, protease and lipase, protease and cellulase, protease and mannanase, amylase and lipase, amylase and cellulase, amylase and mannanase, lipase and cellulase, lipase and mannanase, lipase and cellulase, protease and amylase and lipase, protease and amylase and cellulase, protease and amylase and mannanase, amylase and lipase and cellulase, amylase and lipase and mannanase, lipase, cellulase and mannanase, protease and amylase and lipase and cellulase, protease and amylase and cellulase and mannanase.

Each further enzyme of this kind is advantageously present in the composition in an amount of 1×10⁻⁸ to 5 percent by weight based on active protein. With increasing preference, every further enzyme is present in the inventive compositions in an amount of 1×10⁻⁷-3% by weight, of 0.00001-1% by weight, of 0.00005-0.5% by weight, of 0.0001 to 0.1% by weight and more preferably of 0.0001% to 0.05% by weight, based on active protein. In this respect, the active protein concentration can be determined in a manner customary in the art, in the case of hydrolases, for example, by a titration of the active sites using a suitable irreversible inhibitor and determination of the residual activity (cf., for example, M. Bender et al., J. Am. Chem. Soc. 88, 24 (1966), p. 5890-5913; the reference cited relates to proteases, but the principle of titration is applicable to the active sites of other hydrolases). More preferably, the enzymes exhibit synergistic cleaning performances with respect to specific stains or spots, meaning that the enzymes present in the composition promote the cleaning performances of one another. Most preferably, such synergism is present between the protease present in accordance with the invention and a further enzyme in an inventive composition, especially between the protease present in accordance with the invention and an amylase and/or a lipase and/or a mannanase and/or a cellulase and/or a pectin-cleaving enzyme. Synergistic effects can occur not just between various enzymes but also between one or more enzymes and further ingredients of the inventive composition.

In a further embodiment of the invention, it is a characteristic feature of the dishwashing detergent that it is a machine dishwashing detergent. According to this application, machine dishwashing detergents refer to compositions which can be used for cleaning soiled dishware in a machine dishwashing process. In this way, the inventive machine dishwashing detergents differ, for example, from the machine rinse aids which are always used in combination with machine dishwashing detergents and do not display any cleaning action themselves. Higher demands are frequently placed on machine-washed dishware than on manually washed dishware. Thus, the dishware after machine cleaning should not just be free of food residues but also should not have, for example, any whitish spots caused by water hardness or other mineral salts, which stem from dried water droplets for lack of wetting agent. Modern machine dishwashing detergents fulfill these demands through the integration of cleaning-active and/or care-active and/or water-softening-active and/or rinse aid-active ingredients and are known to the consumer, for example, as “10 in 1” or “11 in 1” dishwashing detergents. As a constituent essential for successful cleaning and rinsing, the machine dishwashing detergents comprise builders. These builders firstly increase the alkalinity of the cleaning liquor, with emulsification and hydrolysis of fats and oils as alkalinity rises, and secondly reduce the water hardness of the cleaning liquor by complexing the calcium ions present in the aqueous liquor.

In a further configuration, the machine dishwashing detergent is surrounded by a water-soluble film. The film preferably comprises a polyvinyl alcohol (PVA) or consists of polyvinyl alcohol (PVA). An inventive machine dishwashing detergent of this kind is accordingly in the form of portions.

The invention further provides for the use of an inventive dishwashing detergent for removing stains, especially protease- and/or amylase-sensitive stains, on hard surfaces, i.e. for cleaning of hard surfaces. This is because inventive compositions can, especially because of the combination of protease and amylase present, advantageously be used to eliminate corresponding impurities from hard surfaces. Embodiments of this subject matter of the invention are, for example, the manual removal of spots from hard surfaces or use in connection with a machine process. All facts, subjects or embodiments described for inventive dishwashing detergents are also applicable to this subject matter of the invention. Therefore, reference is made explicitly here to the disclosure at the corresponding point, with the pointer that this disclosure also applies to the above inventive use.

The invention further provides a method for cleaning hard surfaces, wherein an inventive dishwashing detergent is used in at least one process step.

Preference is given to a machine dishwashing method. The dishwashing detergent is preferably dosed into the interior of a machine dishwasher during the running of a dishwashing program, prior to commencement of the main wash cycle or in the course of the main wash cycle. The metering or introduction of the inventive composition into the interior of the machine dishwasher can be effected manually, but the composition is preferably dosed into the interior of the machine dishwasher by means of the dosage chamber of the machine dishwasher. In the course of the cleaning process, preferably no additional water softener and no additional rinse aid is dosed into the interior of the machine dishwasher. All facts, subjects and embodiments described for inventive dishwashing detergents or the use thereof are also applicable to methods of the invention. Therefore, reference is made here explicitly to the disclosure at the corresponding point, with the pointer that this disclosure also applies to the above methods of the invention.

In a preferred embodiment, it is a characteristic feature of the process that the amylase is present in the cleaning liquor in a concentration of 1×10⁻¹⁰-0.2% by weight, of 0.000001-0.12% by weight, of 0.000005-0.04% by weight, of 0.00001% to 0.03% by weight and more preferably of 0.00005% to 0.02% by weight, and/or that the protease is present in the cleaning liquor in a concentration of 1×10⁻¹⁰-0.2% by weight, of 0.000001-0.12% by weight, of 0.000005-0.04% by weight, of 0.00001% to 0.03% by weight and more preferably of 0.00005% to 0.02% by weight, where the figures given are based on active protein in the cleaning liquor. In a further preferred embodiment, it is a characteristic feature of the process that it is conducted at a temperature between 10° C. and 70° C., preferably between 20° C. and 60° C. and more preferably between 30° C. and 50° C.

Proteases used in inventive compositions are, in accordance with the details above, advantageously usable in inventive dishwashing detergents and methods, especially machine dishwashing methods. They can thus be used advantageously to provide proteolytic activity in corresponding compositions.

The invention therefore further provides for the use of a protease comprising an amino acid sequence having at least 70% identity over its total length with the amino acid sequence specified in SEQ ID NO. 1 and having, in the listing according to SEQ ID NO. 1, the L211D amino acid substitution in combination with at least two further amino acid substitutions selected from the group consisting of S3T, V4I, V193M and V199I, for provision of proteolytic activity in a liquid dishwashing detergent further comprising an amylase.

All facts, subjects and embodiments described for inventive dishwashing detergents, uses or methods are also applicable to these uses. Therefore, reference is made explicitly here to the disclosure at the corresponding point, with the pointer that this disclosure also applies to the above inventive uses.

Example: Determination of the storage stability of an inventive liquid machine dishwashing detergent

The base formulation used was an amylase-containing biphasic liquid machine dishwashing detergent of the following composition (all figures in percent by weight):

(a) Enzyme phase:

### Builder 18.0

Sugar alcohol 12.0
Nonionic surfactant (C8-C10 fatty alcohol
ethoxylate with 22 EO) 5.0
Alkali metal compound (base) 3.5
Boric acid 3.0

### Phosphonate (HEDP) 1.5

### Amylase 1.2

Ca salt 1.2
Zn salt 0.2

### Thickener 1.0

Dye, perfume, preservative 0.3

### Water ad 97

The amylase present was an α-amylase variant which, compared to the α-amylase AA560 according to SEQ ID NO. 3, has the following sequence modifications in the listing of the α-amylase AA560: R118K, D183* (deletion), G184* (deletion), N195F, R320K, R458K (from Novozymes).

(b) Alkaline phase:

### Builder 12.0

Sodium carbonate 10.0
Sulfo polymer 7.0
Alkali metal compound (base) 4.0

### Monoethanolamine 3.5

### Phosphonate (HEDP) 4.0

### Thickener 1.0

Dye, perfume, preservative 0.3

### Water ad 100

The enzyme phase of the base formulation for the different test batches was admixed with 3% by weight or 3.5% by weight of preparations of the following proteases (resulting in each case, respectively, in 0.5% by weight and 0.58% by weight of active protein):

Batch 1: performance-enhanced variant of the protease from Bacillus lentus according to SEQ ID NO. 2 of WO2011/032988 (reference);

Batch 2: protease according to SEQ ID NO. 2 (SEQ ID NO. 1+S3T+V4I+V193M+V199I+L211D).

To determine the cleaning performance, the two phases were dosed in equal portions (20 g of each phase). Washing was effected within a pH range between pH 9 and pH 10 in a Miele G698SC machine dishwasher in a volume of 4 liters for a period of 60 minutes at a temperature of 50° C.

Dishware with the following stains was used: minced meat (A), egg yolk (B), oat flakes (C) and starch (D).

The cleaning performance is rated visually by the standard IKW method on a scale from 1 to 10, the value of 10 being the best mark (no discernible residue).

The cleaning compositions of batches 1 and 2 were tested with respect to their cleaning performance before and after storage at 40° C. for four weeks. The results are summarized in table 1 below:

TABLE 1

| | Protease | | | | |
|---|---|---|---|---|---|
| | concentration (% by | | | | |
| Stain | weight) | A | B | C | D |
| Batch 1 before storage | 3 | 10.0 | 5.6 | 8.9 | 9.4 |
| | 3.5 | 10.0 | 5.9 | 8.6 | 9.2 |
| Batch 2 before storage | 3 | 10.0 | 5.7 | 8.4 | 9.2 |
| | 3.5 | 10.0 | 5.8 | 8.6 | 9.3 |
| Batch 1 after storage | 3 | 2.8 | 1.2 | 5.6 | 5.5 |
| | 3.5 | 3.2 | 1.3 | 5.8 | 5.6 |
| Batch 2 after storage | 3 | 6.0 | 2.5 | 5.9 | 5.8 |
| | 3.5 | 6.8 | 3.2 | 6.1 | 6.5 |

After storage at 40° C. for four weeks, it is clearly apparent that the inventive composition—by virtue of the protease present—exhibits distinctly improved cleaning performance, especially on the protease-sensitive stains A and B (proteolytic cleaning performance). In addition, the cleaning performance on amylase-sensitive stains C and D is also improved (amylolytic cleaning performance).

1. A liquid dishwashing detergent comprising
(a) a protease comprising an amino acid sequence having at least 70% identity over its total length with the amino acid sequence specified in SEQ ID NO. 1 and having, in the listing according to SEQ ID NO. 1, the L211D amino acid substitution in combination with at least two further amino acid substitutions selected from the group consisting of S3T, V4I, V193M and V199I, and
(b) an amylase.

2. The dishwashing detergent according to claim 1, wherein the protease comprises an amino acid sequence having at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98% or 98.5% identity over its total length with the amino acid sequence specified in SEQ ID NO. 1 and having, in the listing according to SEQ ID NO. 1, the L211D amino acid substitution in combination with the S3T, V4I, V193M and V199I amino acid substitutions.

3. The dishwashing detergent according to claim 1, wherein
the protease at position 99 has the amino acid arginine (R),
the protease at position 188 has the amino acid alanine (A), and/or
the protease has an amino acid sequence according to SEQ ID NO. 2.

4. The dishwashing detergent according to claim 1, wherein the amylase is an α-amylase variant of the α-amylase AA560 according to SEQ ID NO. 3 having one, two, three, four, five or six of the following sequence modifications in the listing according to the α-amylase AA560: R118K, D183* (deletion), G184* (deletion), N195F, Sk320K, R458K.

5. The dishwashing detergent according to claim 1, wherein the amylase is present in an amount of 1×10⁻⁸ to 5 percent by weight, based on active protein, and/or the protease is present in an amount of 1×10⁻⁸ to 5 percent by weight, based on active protein.

6. The dishwashing detergent according to claim 1, which further comprises a component selected from
i. anionic and/or polyanionic substance,
ii. cationic and/or polycationic substance, and/or
iii. substance having hydroxyl group(s) and/or polyhydroxyl group(s).

7. The dishwashing detergent according to claim 1, which comprises at least one further ingredient selected from the group consisting of builder, surfactant, anionic polymer and combinations thereof.

8. The dishwashing detergent according to claim 1, which comprises at least one further enzyme, especially a protease, amylase, cellulase, hemicellulase, mannanase, tannase, xylanase, xanthanase, xyloglucanase, β-glucosidase, pectinase, carrageenase, perhydrolase, oxidase, oxidoreductase or a lipase, and mixtures thereof.

9. The dishwashing detergent according to claim 1, which is a machine dishwashing detergent.

10. A method for removing protease-sensitive stains on hard surfaces comprising using the dishwashing detergent according to claim 1.

11. A method for cleaning hard surfaces, which comprises using the dishwashing detergent according to claim 1 in at least one method step.

12. The method according to claim 11, wherein the amylase is present in the cleaning liquor in a concentration of 1×10⁻¹⁰-0.2% by weight, and/or the protease is present in the cleaning liquor in a concentration of 1×10⁻¹⁰-0.2% by weight.

13. The method according to claim 11, which is conducted at a temperature between 10° C. and 70° C., between 20° C. and 60° C., or between 30° C. and 50° C.

14. A method for providing proteolytic activity in a liquid dishwashing detergent comprising using
(a) a protease comprising an amino acid sequence having at least 70% identity over its total length with the amino acid sequence specified in SEQ ID NO. 1 and having, in the listing according to SEQ ID NO. 1, the L211D amino acid substitution in combination with at least two further amino acid substitutions selected from the group consisting of S3T, V4I, V193M and V199I, and
(b) an amylase.


SEQUENCE LISTING (3 sequences)

SEQ ID NO: 1 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Bacillus lentus
AQTIPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIMAPGVNIQSTYPGSTYASDNGTSMATPHVAGAAALVKQKNPSWSNVQIRNHLKNTATSLGSTNLYGSGLVNAEAATR

SEQ ID NO: 3 - protein, 485 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK